(19) United States
(12) Patent Application Publication
(10) Pub. No.: US 2008/0052094 A1
(43) Pub. Date: Feb. 28, 2008

(54) WATER DISPENSING SYSTEMS AND METHODS

(75) Inventors: Anastasios Morfopoulos, North Vancouver (CA); Jason Fahlman, North Vancouver (CA)

Correspondence Address: OYEN, WIGGS, GREEN & MUTALA LLP;480 - THE STATION, 601 WEST CORDOVA STREET, VANCOUVER, BC, V6B 1G1, US

(73) Assignee: IMG MANAGEMENT GROUP INC., North Vancouver, BC (CA)

(21) Appl. No.: 11/467,106

(22) Filed: Aug. 24, 2006

(51) Int. Cl. G06Q 10/00; B01D 35/00; B01D 21/24; B67D 5/08

(52) U.S. Cl. 705/1; 210/90; 210/109; 210/257.2; 210/182; 210/259; 222/52; 222/22

(57) ABSTRACT

A system for dispensing water comprises a water processing system comprising an input connected to receive water from a water supply system and an output configured to dispense a metered amount of processed water, the water processing system defining a closed path between the input and the output, a control system operatively coupled to the water processing system for controlling the dispensing of processed water from the output, and, a user interface operatively coupled to the control system for permitting a user to cause the output to dispense a desired amount of processed water. The user interface comprises control means for starting and stopping a flow of processed water from the output and logging means for debiting the amount of process water dispensed from the output from a user account.

### TECHNICAL FIELD

The invention relates to dispensing water, and more particularly to systems and methods for dispensing filtered, purified and/or sterilized water to users while metering the amount of water dispensed.

### BACKGROUND

There exist various prior art systems for dispensing filtered water. Some prior art water dispensing systems use storage tanks for storing filtered water. Such storage tanks can increase the overall footprint of these systems, making it less desirable to install such systems at locations where space is at a premium. Also, such storage tanks may be open to the atmosphere, which may result in stagnation and/or contamination of the stored water and require periodic dumping or re-treatment of the stored water.

Some prior art water dispensing systems dispense water at a high flow rate (e.g., 2-7 gallons per minute), and/or only dispense water in relatively large increments (e.g., ½ gallon). Such systems may be desirable for filling large containers, but can be inconvenient for a user wishing to fill smaller containers, or wishing to top up the water in a sports bottle or similar vessel.

Some prior art water dispensing systems make use of contact-type card interfaces. Such contact-type card interfaces allow information on a user's card to be updated to reflect multiple transactions, but may be prone to mechanical and maintenance problems. Other prior art water dispensing systems make use of contactless-type card interfaces. Such contactless-type card interfaces allow a user to pass their card (or other item with an embedded integrated circuit) near the interface to activate the water dispensing system, but typically only provide the water dispensing system with a user identification, and thus may not be suitable for situations wherein the user wishes to conduct multiple transactions.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a system for dispensing water. The system comprises a water processing system comprising an input connected to receive water from a water supply system and an output configured to dispense a metered amount of processed water, the water processing system defining a closed path between the input and the output, a control system operatively coupled to the water processing system for controlling the dispensing of processed water from the output, and, a user interface operatively coupled to the control system for permitting a user to cause the output to dispense a desired amount of processed water. The user interface comprises control means for starting and stopping a flow of processed water from the output and logging means for debiting the amount of process water dispensed from the output from a user account.

Another aspect of the invention provides a method for dispensing water from a water processing system comprising an input connected to receive water from a water supply system and an output configured to dispense a metered amount of processed water, the water processing system defining a closed path between the input and the output. The method comprises receiving account information from a card inserted into an insertion slot by means of a contactless smart card system, determining from the account information whether the inserted card has credits for dispensing water stored thereon, and, while the inserted card has credits for dispensing water: activating the water processing system; receiving a signal to start dispensing water; dispensing processed water; debiting an amount of dispensed water from the inserted card; and, receiving a signal to stop dispensing water.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

In drawings which illustrate non-limiting embodiments of the invention:

FIG. 1 shows a system for dispensing water according to one embodiment of the invention;

FIG. 1A shows a portion of a system for dispensing water according to another embodiment of the invention;

FIG. 2 shows a method for dispensing water according to another embodiment of the invention;

FIGS. 3 and 4 show a system for dispensing water according to another embodiment of the invention;

FIG. 5 shows an example water dispensing apparatus according to another embodiment of the invention; and,

FIG. 6 shows the system for dispensing water in the example water dispensing apparatus of FIG. 5.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The invention provides systems and methods for dispensing water. Systems according to some embodiments of the invention provide a closed (i.e., not open to the atmosphere) pathway between an input and an output. A purification system is located along the closed pathway between the input and the output. The input is connected to receive water from a water supply system such as, for example a municipal water supply system. The output is configured to dispense a metered amount of water under the control of a control system. A user interface is operatively coupled to the control system to allow a user to start and stop the flow of purified water being dispensed from the output. The user interface also comprises logging means for debiting the amount of purified water dispensed from the output from a user account. In some embodiments the logging means comprises a contactless smart card system.

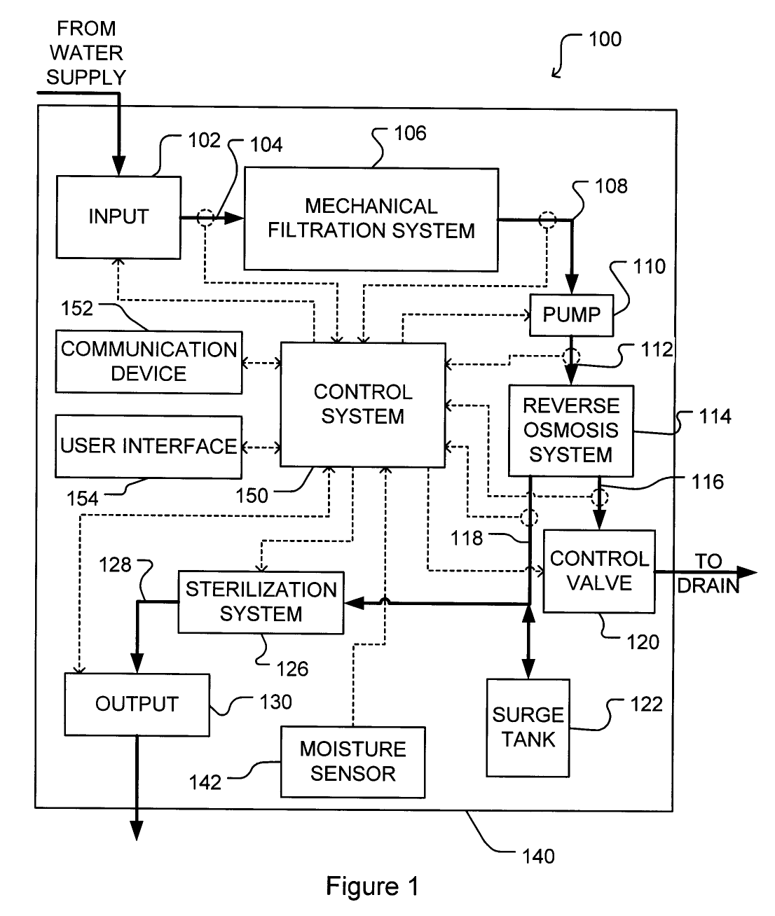

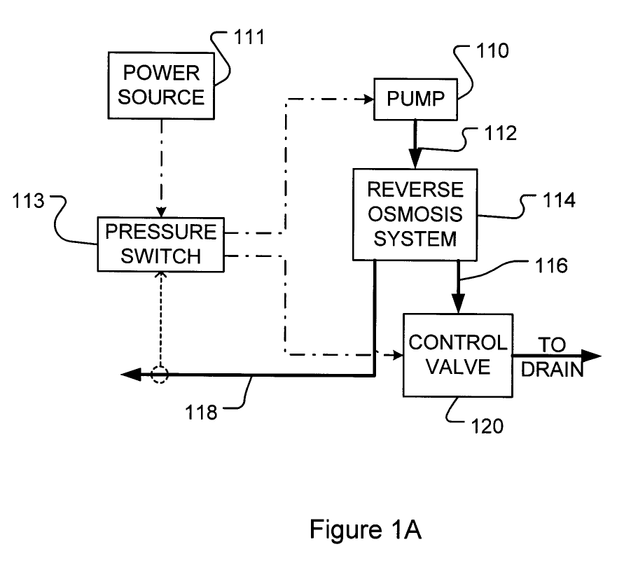

FIG. 1 shows a system 100 for dispensing water according to one embodiment of the invention. System 100 comprises an input 102 which is connected to receive water from a water supply system. Input 102 may comprise one or more valves which control the flow of water into system 100 under the control of a control system 150. Input 102 may also comprise a check valve. A check valve is a one way valve which prevents backflow into the water supply system, and is required in some jurisdictions. Control system 150 may comprise a processor coupled to a memory having stored thereon computer readable instructions which, when executed by the processor, perform steps of a method according to the invention, as described further below. Control system 150 may cut off the flow of water into system 100 in the event of any problems being detected in system 100. In FIG. 1, thick solid lines are used to represent lines through which water flows, and dashed lines are used to represent lines carrying sensor and control signals to and from control system 150.

Input 102 may also comprise a temperature sensor and heating means for heating the water received from the water supply. The production rate of reverse osmosis membranes increases with the temperature of the feed water supplied to the membranes. The inventors have determined that in systems comprising reverse osmosis membranes is it desirable to heat the water received from the water supply to the maximum temperature possible within the manufacturer's recommended operating parameters for the membranes.

In some embodiments, the heating means may comprise an inline water heater. In such embodiments, control system 150 receives a measurement of the incoming water temperature from the temperature sensor and runs the heater at a duty cycle sufficient to adjust the temperature to a desired level based on the temperature and flow of water. In some embodiments, the heating means may comprise a proportional valve coupled to a hot water supply, which is mixed with water form a cold water supply. In such embodiments, control system 150 receives a measurement of the temperature of the mixed hot and cold water and adjusts the proportional valve to control the relative proportion of hot water to cold water to adjust the temperature to the desired level.

Water from input 102 is forced through a line 104 and into a mechanical filtration system 106 by the pressure provided by the water supply. Mechanical filtration system 106 may, for example, remove particles from the water having a size of five microns or larger. Mechanical filtration system 106 may also remove chlorine from the water. The specific characteristics of mechanical filtration system 106 may be selected based on the expected flow rate and the requirements of the reverse osmosis membranes.

A pressure sensor may be provided in line 104 to provide control system 150 with a measurement of the pressure in line 104. Control system 150 may shut down system 100 and stop water from entering input 102 if the pressure in line 104 is outside of a predetermined acceptable range. Control system 150 may also send an alert to a system administrator by means of a communication device 152.

Communication device 152 may comprise, for example, a modem or the like having an ethernet, wireless, or other connection to a network. An administrative database may be accessible by means of the network, so that control system 150 may query the administrative database by means of communication device 152, as described below.

Filtered water from mechanical filtration system 106 is forced through a line 108 and into a pump 110 by the pressure provided by the water supply. A pressure sensor may be provided in line 108 to provide control system 150 with a measurement of the pressure in line 108. Control system 150 may shut down system 100 and stop water from entering input 102 if the pressure in line 108 is outside of a predetermined acceptable range. Control system 150 may also send an alert to the system administrator by means of communication device 152.

Control system 150 may monitor the difference in pressure across mechanical filtration system 106 by comparing the pressure in line 104 to the pressure in line 108. If the pressure drop across mechanical filtration system 106 exceeds a predetermined threshold, control system 150 may notify the system administrator that mechanical filtration system 106 needs servicing by means of communication device 152. One or more flush valves (not shown in FIG. 1) may be provided in line 108 to allow water to be flushed through mechanical filtration system 106 when new filters are installed.

Pump 110 may be selectively activated and deactivated by control system 150 in response to pressure measurements received from pressure sensors downstream of pump 110, as described below. A re-circulation loop (not shown) may be provided to prevent pump 110 from cavitating in the event that the flow of water into line 108 is insufficient for smooth operation of pump 110. In some embodiments, pump 110 may include a built in re-circulation loop. In other embodiments, a re-circulation line (not shown) may be provided to connect line 112 to line 108 through a re-circulation valve (not shown). The re-circulation valve may be operated under the control of control system 150, or may be a manually operated valve that may be calibrated upon the installation of system 100.

When activated, pump 110 forces filtered water from line 108 into line 112 and then into a reverse osmosis (RO) system 114 at an increased pressure. The level of increased pressure provided by pump 110 may be determined based on the characteristics of RO system 114. For example, RO system 114 may comprise one or more “conventional” membranes which may operate with a feed pressure in the range of 300-500 psi, or may comprise one or more “low pressure” membranes which may operate with a feed pressure in the range of 100-150 psi. Conventional membranes typically cost less than low pressure membranes, but the use of conventional membranes requires the rest of system 100 downstream of RO system 114 to operate at higher pressures, which can result in an increased overall footprint of system 100. Also, if RO system 114 is to operate at higher pressures, the cost of components downstream of RO system 114 will be higher than if RO system 114 operates at lower pressures. The inventors have determined that the use of low pressure RO membranes is desirable in many embodiments.

RO system 114 removes contaminants and bacteria from water as the water is forced through RO system 114. RO system 114 may comprise, for example, one RO membrane connected to receive water from line 112, or a plurality of RO membranes connected in series, parallel or series-parallel to receive water from line 112. The RO membranes may comprise, for example, low pressure RO membranes. RO system 114 may be configured to produce a predetermined rejection ratio for expected flow rates. Rejection ratio is a measure of the reduction of total dissolved solids (TDS) in water as it passes from a first side (the “feed” side) to a second side (the “product” side) of RO system 114. Rejection ratio may be calculated, for example, as 1−(TDS_{product}/TDS_{feed}), where TDS_{product} and TDS_{feed} are the TDS levels on the product and feed sides of RO system 114, respectively. The expected flow rates across RO system 114 may, for example, range from 0 up to 1 or 2 gallons per minute.

A TDS sensor may be provided in line 112 to provide control system 150 with a measurement of TDS in line 112. A TDS sensor may also be provided in line 118 to provide control system 150 with a measurement of TDS in line 118.

Control system 150 may monitor the efficiency of RO system 114 by comparing TDS in line 112 to TDS in line 118. Control system 150 may also calculate the rejection ratio across RO system 114. If the rejection ratio of RO system 114 fall below a predetermined level, control system 150 may notify the system administrator that RO system 114 needs servicing by means of communication system 152. The rejection ratio of RO membranes typically decreases with age, and may decrease more rapidly if water is forced through the membranes at higher pressure than the maximum pressure for which the membranes are designed.

A pressure sensor may be provided in line 112 to provide control system 150 with a measurement of the pressure in line 112. Pressure sensors may also be provided in lines 116 and 118 to provide control system 150 with measurements of the pressures in lines 116 and 118.

Control system 150 may monitor the difference in pressure across RO system 114 by comparing the pressure in line 112 to the pressure in lines 116 and 118. If the pressure drop across RO system 114 exceeds a predetermined threshold during normal operation (e.g., not when RO system 114 is being flushed), control system 150 may notify the system administrator that RO system 114 needs servicing by means of communication system 152.

When pump 110 is active, water is forced through RO system 114. Waste water exits RO system 14 through line 116 and purified product water exits through line 118. Line 116 is connected to a proportional control valve 120 which may be partially opened and closed by control system 150 to control the back pressure to the waste water output of RO system 114. The flow of water across RO system 114 and into line 118 may be increased and decreased by controlling the amount which control valve 120 is open. Control system 150 may fully open control valve 120 in order to flush out any contaminant buildup from RO system 114.

Control system 150 may monitor the pressure in line 118 and activate pump 110 when the pressure in line 118 falls below a predetermined minimum pressure. The pressure in line 118 may fall, for example, as a result of a user dispensing water from system 100. Control system 150 may deactivate pump 110 when the pressure in line 118 rises above a predetermined maximum pressure. The pressure in line 118 may rise, for example, as a result of pump 110 being active while no water is being dispensed from system 100.

Alternatively, as shown in FIG. 1A, pump 110 may be electrically connected to a power source 111 through a pressure switch 113. Pressure switch 113 may be coupled to monitor the pressure in line 118 and configured to close (thereby activating pump 110) when the pressure in line 118 falls below a first predetermined RO output pressure, and open (thereby deactivating pump 110) when the pressure in line 118 exceeds a second predetermined RO output pressure which is higher than the first predetermined RO output pressure, such that pump 110 operates within a desired RO output pressure range. For example, pressure switch 113 may close when the pressure in line 118 falls below 20 psi, and open when the pressure in line 118 exceeds 40 psi. Pressure switch 113 may also provide electrical power from power source 111 to control valve 120 in some embodiments. In such embodiments, control valve 120 may be configured to be in a partially open position (providing back pressure to line 116) during normal operation. Control valve 120 may comprise a flow restrictor which facilitates partial opening of control valve 120. Control valve 120 may also comprise a built in timing circuit such that when control valve 120 is receiving power through pressure switch 113, control valve 120 periodically switches to a fully open position for a predetermined time period to flush out any contaminant buildup from RO system 114.

Line 118 may be in fluid communication with a surge tank 122. Surge tank 122 may comprise a sealed expansion tank maintained under pressure. The pressure of water in surge tank 122 may be used for dispensing water when system 100 is activated by a user but before pump 110 has had time to build up sufficient pressure across RO system 114. The pressure of water in surge tank 122 may also be used to provide back pressure to RO system 114 when system 100 is inactive. Back pressure prevents creep of water and contaminants across the membranes of RO system 114.

Water in line 118 is provided to a sterilization system 126. Sterilization system 126 may comprise, for example, an ultraviolet (UV) lamp which sterilizes the water with UV radiation. Alternatively sterilization system 126 may comprise an ozone injector which sterilizes the water by injecting ozone.

After passing through sterilization system 126, water passes through line 128 to an output 130. Output 130 comprises a dispensing valve which may be selectively opened by control system 150 in response to signals received from a user interface 154 to allow water to be dispensed to a user. Output 130 also comprises a flow meter which provides control system 150 with a measurement of the amount of water dispensed to the user. In some embodiments, the dispensing valve and flow meter may be combined in a single element.

Output 130 may also comprise a dispensing nozzle which aerates the water as it is dispensed, and creates a shaped flow which may readily pass through the opening of small bottles. For example, the dispensing nozzle may provide a flow of water shaped to fill a vessel such as a bottle having an opening with a diameter of one inch or less. For example, the dispensing nozzle may shape the flow to fit through an opening with a diameter of approximately 0.75 inches with little or no spillage.

User interface 154 may comprise, for example, a contactless smart card system and a start/stop button. Alternatively or additionally, user interface 154 may comprise a keyboard or touch pad for entering user data, selecting the volume to be dispensed, etc. User interface 154 could also optionally comprise a joystick-style feedback mechanism, or manual valve, for providing the user with control of the output flow rate to dispense water in a controlled fashion for filling very small containers. User interface 154 may also comprise a display such as a liquid crystal display (LCD) or the like for displaying information about the user account, the status of system 100 and/or advertising material to the user.

A user may cause system 100 to dispense water, for example, by inserting a card linked to a user account issued by the system administrator into the contactless smart card system, pressing the start/stop button once to start dispensing water, and then pressing the start/stop button again to stop dispensing water. Such an example configuration of system 100 has the advantage of simplicity of use, and may be suitable for a wide variety of settings, such as residences, workplaces and exercise facilities.

The contactless smart card system may comprise a card insertion slot which is sealed off and electrically insulated from the rest of system 100. The user's card may remain in the slot during the entire dispensing process, thus permitting control system 150 to periodically or continuously update the user's card to reflect the amount of water dispensed from system 100. Accordingly, the contactless smart card system and card insertion slot provide the benefits of multiple transactions without the mechanical and maintenance problems associated with contact-based card systems.

System 100 may be enclosed within a housing 140. A moisture sensor 142 may be located near the bottom of housing 140. Moisture sensor 142 may provide control system 150 with a warning signal if water is detected. If control system 150 receives a warning signal from moisture sensor 142, control system 150 may close input 102, shut down system 100, and notify the system administrator by means of communication system 152 that there may be a leak.

In operation, a user may set up an account with the system administrator and obtain a smart card linked to the user's account. The smart card may be filled with credits which are debited as the user dispenses water from system 100. The smart card may also be assigned an expiration date. Alternatively a smart card may be set up as an unlimited volume card which may be prepaid and used to dispense water from system 100 for a predetermined time period, or may be set up to track the amount of water dispensed from system 100, with the user being periodically billed for the amount of water dispensed in the previous billing period. A user may activate system 100 by means of user interface 154, for example by inserting the smart card into the card insertion slot. The user may start dispensing water by pressing the start/stop button, and stop dispensing water by pressing the start/stop button again. Thus, the user may dispense any desired amount of water. For example, control system 150 may be configured to dispense water in increments of any desired volume. In some embodiments, control system 150 dispenses water in increments of 100 ml. Control system 150 monitors the amount of water dispensed and debits the smart cart accordingly. Control system 150 may be programmed to cut off the flow of water being dispensed if the smart card is removed, or if all of the credits on the smart card have been used.

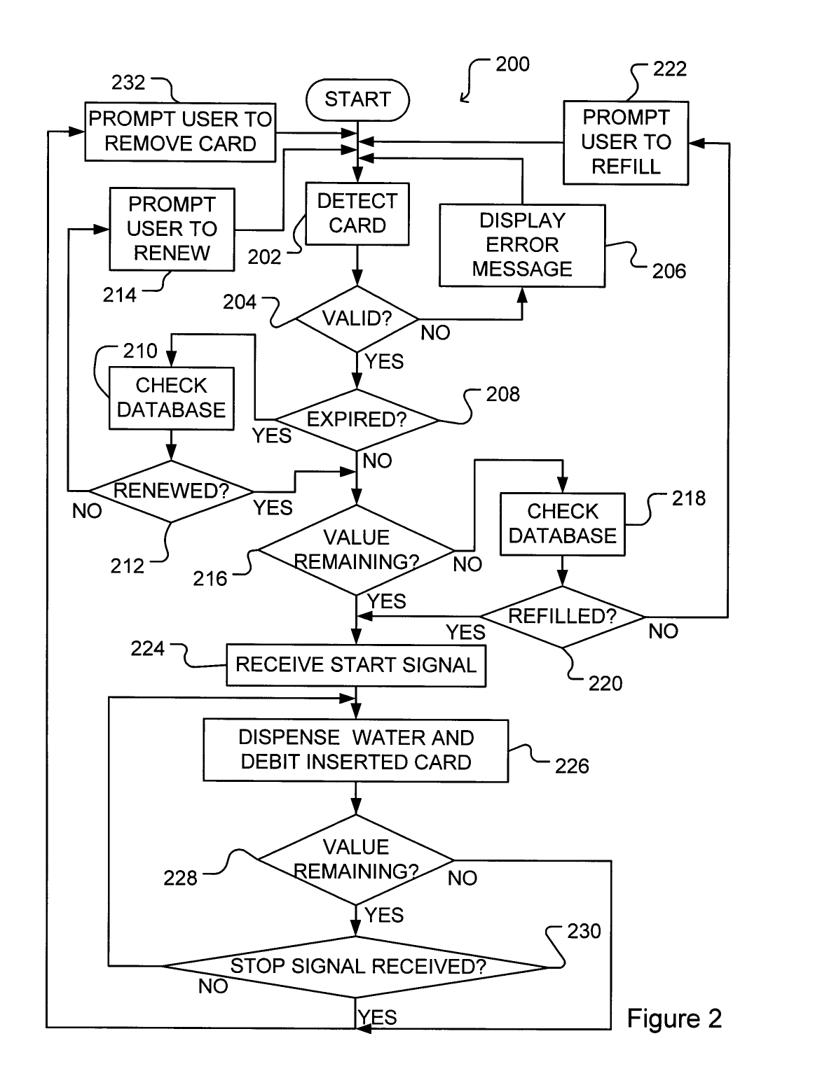

FIG. 2 shows a method 200 for dispensing water according to one embodiment of the invention. Method 200 may be carried out, for example, by a processor of a control system of a water dispensing system having a user interface comprising a smart card system.

Method 200 begins at block 202, where the smart card system detects a smart card in a card insertion slot and provides information about the smart card to the processor. If the inserted card is removed at any point during method 200, or if there is a malfunction which prevents the smart card system from updating the information stored on the inserted card, any dispensing of water is stopped and method 200 returns to block 202 to await the insertion of another smart card.

At block 204, the processor determines if the inserted card is valid, for example by comparing the information received from the smart card system to information stored in a memory accessible to the processor. If the inserted card is not valid (block 204 NO output), the processor causes an error message to be displayed at block 206 and method 200 returns to block 202 to await the insertion of another smart card.

If the inserted card is valid (block 204 YES output), method 200 proceeds to block 208 where the processor determines if the card has expired. If the inserted card has expired (block 208 YES output), the processor attempts to check an external administrative database at block 210, for example, by means of a communication device. If the processor is unable to connect to the administrative database, the processor may cause an error message to be displayed and method 200 returns to block 202 to await the insertion of another smart card. If the processor is able to connect to the administrative database, at block 212 the processor determines if the inserted card has been renewed. If the inserted card has not been renewed (block 212 NO output), the processor may prompt the user to renew the inserted card at block 214, for example by causing an appropriate message to be displayed, and method 200 returns to block 202 to await the insertion of another smart card.

If the inserted card has not expired (block 208 NO output) or has been renewed (block 212 YES output), method 200 proceeds to block 216, where the processor determines if the inserted card has any value remaining thereon which may be used to dispense water. If the inserted card has no value remaining (block 216 NO output), the processor attempts to check the administrative database at block 218. If the processor is unable to connect to the administrative database, the processor may cause an error message to be displayed and method 200 returns to block 202 to await the insertion of another smart card. If the processor is able to connect to the administrative database, at block 220 the processor determines if the inserted card has been refilled. If the inserted card has not been refilled (block 220 NO output), the processor may prompt the user to refill the inserted card at block 222, for example by causing an appropriate message to be displayed, and method 200 returns to block 202 to await the insertion of another smart card.

If the inserted card has value remaining (block 216 YES output) or has been refilled (block 220 YES output), method 200 proceeds to block 224 where the processor waits to receive a start signal. When a start signal is received method 200 proceeds to block 226 where the processor causes the control system to dispense one unit of water and debit the inserted card. The volume of one unit of water may be determined by the system administrator, and may be, for example 100 ml or less.

After each unit of water is dispensed and the inserted card has been debited at block 226, method 200 proceeds to block 228 where the processor determines if the inserted card has any value remaining. If the inserted card has value remaining (block 228 YES output), method 200 proceeds to block 230 where the processor determines if a stop signal has been received from the user interface. If a stop signal has not been received (block 230 NO output), method 200 returns to block 226 and another unit of water is dispensed and debited from the inserted card.

Method 200 continues to cycle through blocks 226, 228 and 230 as long as the inserted card has value remaining and a stop signal is not received. Method 200 may cycle through blocks 226, 228 and 230 at a rate sufficiently fast to permit a continuous flow of dispensed water. Once the inserted card has no remaining value (block 228 NO output) or a stop signal is received (block 230 YES output), method 200 proceeds to block 232 where the user is prompted to remove the inserted card, then returns to block 202 to await the insertion of another smart card.

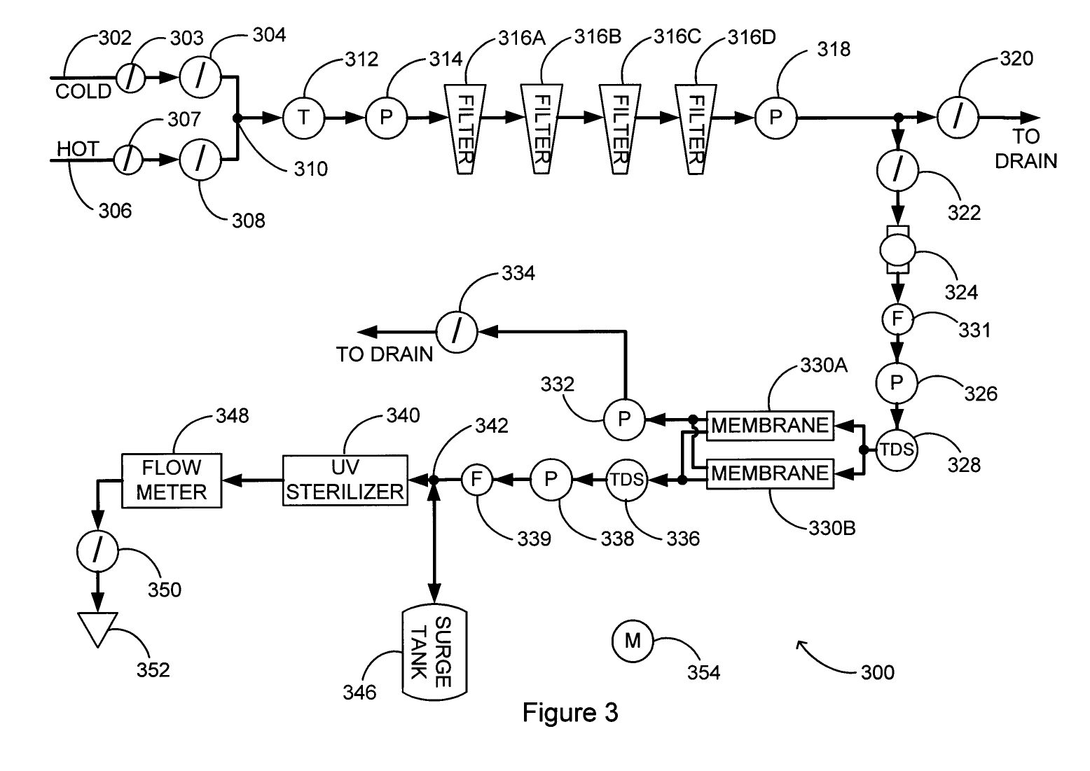

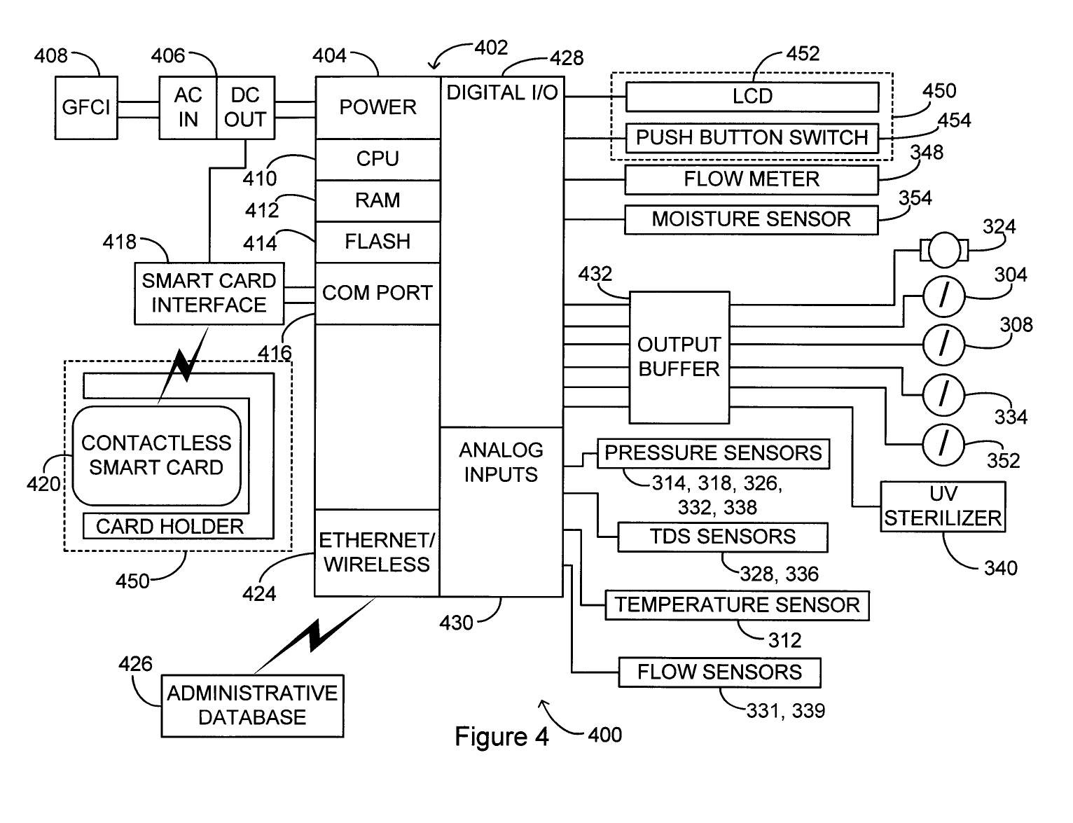

FIGS. 3 and 4 show an example water dispensing system according to another embodiment of the invention. A water processing system 300 is shown in FIG. 3, and a control system 400 and user interface 450 are shown in FIG. 4. It is to be understood that the embodiment shown in FIGS. 3 and 4 includes a number of features which may not be required in all embodiments of the invention.

As shown in FIG. 3, system 300 comprises a cold water source 302 coupled to a cold water valve 304 and a hot water source 306 coupled to a hot water valve 308. System 300 may also comprise check valves 303 and 307 located upstream of cold and hot water valves 304 and 308, respectively, to prevent backflow into the water supply system. At least one of cold and hot water valves 304 and 308 comprises a proportional valve, and the other may comprise either a simple on/off valve or a proportional valve. The outputs of valves 304 and 308 are combined at junction 310, and the mixed cold and hot water (the “feed water”) passes through a temperature sensor 312. Temperature sensor 312 provides control system 400 with a measurement of the temperature of the feed water, so that control system 400 may adjust valves 304 and 308 to achieve a feed water temperature within a desired range. The upper limit of the desired range of the feed water temperature may be, for example at or near the upper limit of the manufacturer's recommended temperature for the RO membranes used in system 300. For example, the upper limit may be approximately 25 degrees Celsius (78 F).

Downstream of temperature sensor 312 the feed water passes through a pressure sensor 314 and then a mechanical filtration system comprising a series of filters 316A-D. In example system 300, filters 316A-D may each comprise a 20 inch filter housing filled with appropriate packing material. For example, filters 316A and 316B may respectively comprise 10 micron and 5 micron filters, filter 316C may comprise a carbon filter and filter 316D may comprise a ceramic filter.

Downstream of filters 316A-D the filtered water passes through another pressure sensor 318 before reaching a filter flush valve 320 and a bypass valve 322. Filter flush and bypass valves 320 and 322 may each comprise either a simple on/off valve or a proportional valve. Filters 316A-D may be flushed by opening filter flush valve 320 and closing bypass valve 322. The filtered water may be provided to a pump 324 by closing filter flush valve 320 and opening bypass valve 322.

The pressure of the filtered water provided to pump 324 is increased by pump 324 when pump 324 is activated, and then the filtered water passes through a flow sensor 331, a pressure sensor 326 and a TDS sensor 328. Downstream of TDS sensor 328, the filtered water passes through a RO system comprising two RO membranes 330A and 330B connected in parallel. The waste and product outputs of membranes 330A and 330B are respectively coupled to provide waste water to a proportional control valve 334 through a pressure sensor 332, and filtered and purified product water to a UV sterilizer 340 through a TDS sensor 336, a pressure sensor 338 and another flow sensor 339. Control valve 334 may be proportionally opened and closed by control system 400 to control the flow of water through membranes 330A and 330B.

Flow sensors 331 and 339 may be used to provide flow information to control system 400 in order to monitor the recovery rate of RO membranes 330A and 330B. The recovery rate is a ratio of product water output from a RO membrane to input water provided to the RO membrane. The desired recovery rate may be, for example, 15% for some RO membranes during normal operation. Flow sensors 331 and 339 could be located in different positions on the input and product sides of RO membranes 330A and 330B, respectively. In embodiments where flow sensors 331 and 339 create pressure drops, flow sensors 331 and 339 are preferably located outside of pressure sensors 326 and 338 so that pressure sensors 326 and 338 do not measure the pressure drops across flow sensors 331 and 339.

A junction 342 is provided between pressure sensor 338 and UV sterilizer 340, which provides fluid communication between the product outputs of membranes 330A and 330B and a surge tank 346. Surge tank 346 provides back pressure to membranes 330A and 330B to prevent creepage when system 300 is not in use, and provides pressure for dispensing water when system 300 is initially activated before pump 324 has time to build up the pressure of the water provided to membranes 330A and 330B.

Downstream of UV sterilizer 340 the filtered, purified and sterilized water is provided to a dispensing valve 350 though a flow meter 348. Dispensing valve 350 may be selectively opened and closed by control system 400. Dispensing valve 350 may comprise a simple on/off valve or may comprise a proportional valve. When dispensing valve 350 is open, water passes though flow meter 348, valve 350 and then a dispensing nozzle 352. A moisture sensor 354 may be provided to send a warning signal to control system 400 in the event of a leak in system 300.

As shown in FIG. 4, control system 400 of the example water dispensing system comprises a single board computer (SBC) 402. SBC 402 is powered by electrical power received at a power input 404 through a converter 406. Converter 406 receives AC electrical power from a GFCI power source 408 and converts the power to DC electrical power.

SBC 402 also comprises a CPU 410. CPU 410 is configured to execute instructions for carrying out steps of methods according to embodiments of the invention, which may be stored in memory such as, for example, RAM 412 or flash memory 414. A communication port 416 allows SBC 404 to communicate with a contactless smart card system 418. Smart card system 418 is positioned to be able to read and update information on a smart card 420 placed within an insertion slot 422, which form part of user interface 450. Insertion slot 422 may be sealed and electrically insulated from the rest of control system 400.

Another port 424, such as for example an ethernet, wireless or similar port allows SBC 402 to communicate with an administrative database 426. Administrative database 426 may be located at a remote location. Administrative database 426 may store information about user accounts associated with smart cards, the functioning of system 300 and other systems managed by the same administrator, and the like.

A plurality of digital I/O ports 428 and analog inputs 430 allow SBC 402 to communicate with various elements of system 300. An output buffer 432 may be provided to boost the voltage of control signals from SBC to elements of system 300 which require voltages higher than those provided by SBC 402. For example, elements such as pump 324, valves 304, 308, 334 and 352, and UV sterilizer 340 may require voltage higher than SBC 402 can supply.

Digital I/O ports 428 also allow SBC 402 to communicate with user interface 450. User interface 450 may comprise, for example, a LCD 452 and a push button switch 454.

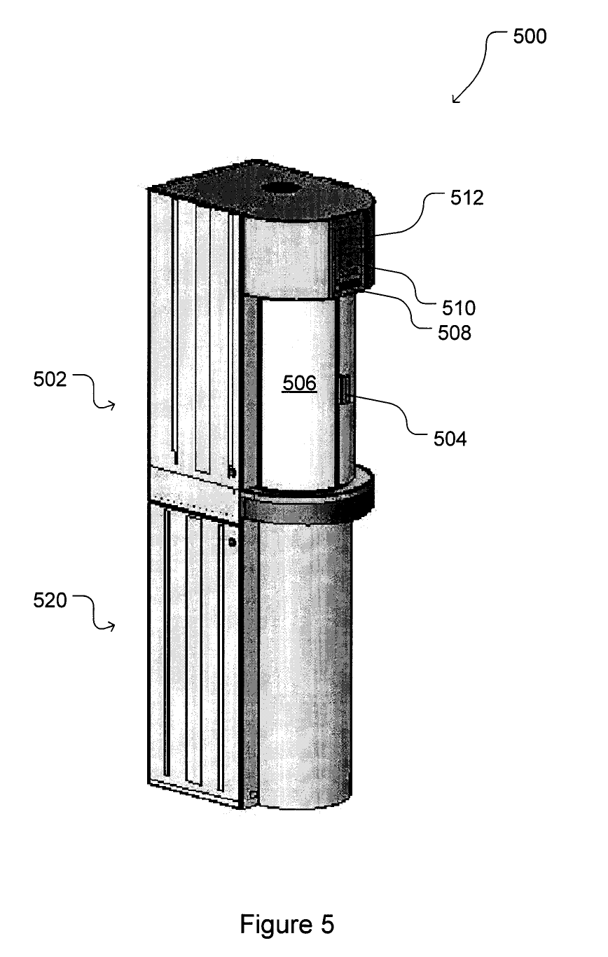

FIG. 5 shows a water dispensing apparatus 500 according to another embodiment of the invention. Apparatus 500 comprises an upper cabinet 502 and a lower cabinet 520. Upper cabinet 502 comprises a splash guard 504 which covers a dispensing compartment 506. At or near the top if dispensing compartment 506 is a dispensing nozzle (not shown in FIG. 5) of a system for dispensing water which is contained in apparatus 500. The system may be activated by inserting a smart card (not shown) into an insertion slot 508. Flow of water from the dispensing nozzle may be started and stopped by pressing a push button switch 510. Push button switch 510 may be lighted. A LCD 512 may display entertainment, advertisements, and/or information about the amount of credits remaining or balance owning on the smart card. The user interface in the example embodiment of FIG. 5, which comprises insertion slot 508, push button switch 510 and LCD 512 provides users with a simple means for dispensing water from apparatus 500, thereby making apparatus 500 suitable for use in a wide variety of settings.

In some embodiments, the system for dispensing water which is contained in apparatus 500 may be located wholly within upper cabinet 502. Lower cabinet 520 may be empty and function only as a support for upper cabinet 502 in such embodiments. Alternatively, lower cabinet 520 may be omitted, and upper cabinet 502 may be supported by a counter, table, or a frame (not shown) mounted to a wall.

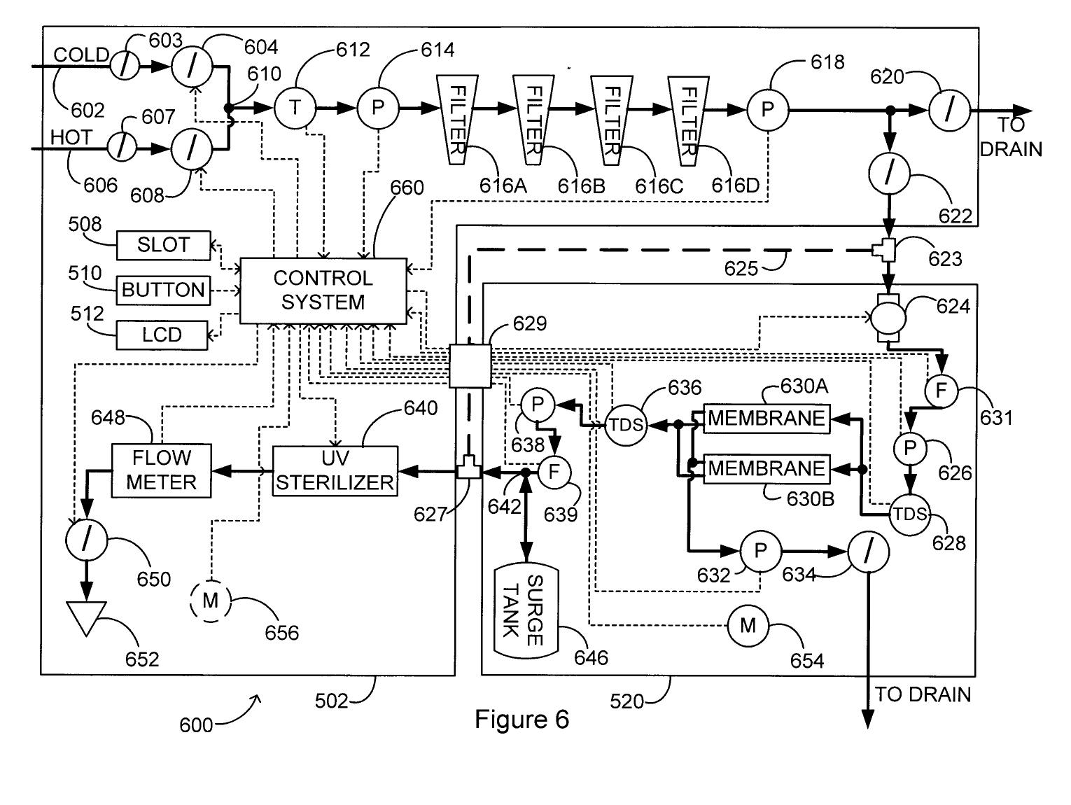

In other embodiments, portions of the system for dispensing water which is contained in apparatus 500 may be located in both of upper and lower cabinets 502 and 520. For example, a portion of the system comprising a RO system may be located within lower cabinet 520, and the remainder of the system may be located within upper cabinet 502. FIG. 6 shows an example system 600 which may be contained in apparatus 500 according to such an embodiment.

System 600 of FIG. 6 is similar to system 300 of FIG. 3. To avoid repetition, elements of system 600 which are the same as corresponding elements of system 300 will not be described in detail. In the FIG. 6 embodiment, elements 602 to 622 are located in upper cabinet 502 along with UV sterilizer 640, flow meter 648, dispensing valve 650, dispensing nozzle 652, moisture sensor 656, control system 660, insertion slot 508, push button 510 and LCD 512. Pump 624, pressure sensors 626, 632 and 638, TDS sensors 628 and 636, RO membranes 630A and 630B, flow meters 631 and 639, control valve 634, junction 642, surge tank 646 and moisture sensor 654 are located in lower cabinet 520.

A T-junction 623 is provided between RO bypass valve 622 and pump 624. Another T-junction 627 is provided between junction 642 and UV sterilizer 640. T-Junctions 623 and 627 may by located at the lower surface of upper cabinet 502. In settings where RO membranes are desired for water purification, T-junction 623 may be connected to provide water to pump 624, and T-junction 627 may be connected to receive water from junction 642, and system 600 functions the same as system 300 of FIG. 3. In such embodiments, moisture sensor 656 is optional, as indicated by the dashed lines outlining moisture sensor 656 in FIG. 6. A connector 629 allows control system 660 in upper cabinet 502 to communicate with various elements of system 600 in lower cabinet 520. Connector 629 may comprise a cable, for example, to facilitate

In settings where RO membranes are not required, T-junction 623 may be connected by line 625 to T-junction 627, and lower cabinet 520 may be bypassed. RO membranes may not be required, for example, where water has a TDS level of 500 parts per million or less, for example. Lower cabinet 520 may be empty or omitted in such embodiments, and upper cabinet 502 may operate as a stand-alone filtering and sterilizing unit.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A system for dispensing water, the system comprising:
a water processing system comprising an input connected to receive water from a water supply system and an output configured to dispense a metered amount of processed water, the water processing system defining a closed path between the input and the output;
a control system operatively coupled to the water processing system for controlling the dispensing of processed water from the output; and,
a user interface operatively coupled to the control system for permitting a user to cause the output to dispense a desired amount of processed water, the user interface comprising control means for starting and stopping a flow of processed water from the output and logging means for debiting the amount of process water dispensed from the output from a user account.

2. A system according to claim 1 wherein the logging means comprises a contactless smart card system.

3. A system according to claim 2 comprising an insertion slot which is sealed and electrically insulated from the remainder of the system, the insertion slot positioned to allow information on a smart card inserted therein to be read and updated by the contactless smart card system.

4. A system according to claim 1 wherein the water processing system comprises a reverse osmosis system having a product water output and a waste water output.

5. A system according to claim 4 wherein the reverse osmosis system comprises a plurality of low pressure reverse osmosis membranes.

6. A system according to claim 4 wherein the reverse osmosis system comprises two low pressure reverse osmosis membranes connected in parallel.

7. A system according to claim 4 comprising a control valve connected between the waste water output of the reverse osmosis system and a drain, the control valve configured to be proportionally opened and closed by the control system to vary a back pressure to the waste water output.

8. A system according to claim 4 wherein the water processing system comprises a pump connected between the input and the reverse osmosis system.

9. A system according to claim 8 comprising a pressure sensor coupled to the control system for measuring the pressure of the product water output of the reverse osmosis system, wherein the control system is configured to activate the pump when the pressure of the product water output of the reverse osmosis system is less than a predetermined minimum pressure.

10. A system according to claim 9 wherein the control system is configured to deactivate the pump when the pressure of the product water output of the reverse osmosis system is greater than a predetermined maximum pressure.

11. A system according to claim 8 comprising a pressure switch connected between the pump and a power source, the pressure switch coupled to monitor the pressure of the product water output of the reverse osmosis system, wherein the pressure switch is configured close to provide power to the pump when the pressure of the product water output of the reverse osmosis system is less than a predetermined minimum pressure, and the pressure switch is configured to open to cut off power to the pump when the pressure of the product water output of the reverse osmosis system is greater than a predetermined maximum pressure.

12. A system according to claim 8 comprising a surge tank connected to a portion of the closed path of the water processing system between the reverse osmosis system and the output.

13. A system according to claim 12 wherein the surge tank is connected to provide back pressure to the product water output of the reverse osmosis system for preventing creepage across the reverse osmosis system when the output is closed.

14. A system according to claim 12 wherein the surge tank is connected to provide water to the output when the output is open and the pump is inactive.

15. A system according to claim 4 wherein the water processing system comprises a mechanical filtration system connected between the input and the reverse osmosis system.

16. A system according to claim 4 wherein the water processing system comprises a sterilization system connected between the reverse osmosis system and the output.

17. A system according to claim 4 wherein the input comprises heating means for heating the water received from the water supply system.

18. A system according to claim 17 wherein the heating means comprises an in-line heater along a cold water input line.

19. A system according to claim 17 wherein the heating means comprises a proportional valve connected to one of a hot water input line and a cold water input line.

20. A system according to claim 1 wherein the control system is configured to dispense purified water from the output in increments of 100 ml or less.

21. A system according to claim 1 wherein the output comprises a dispensing nozzle which aerates the purified water as the purified water is dispensed.

22. A system according to claim 21 wherein the dispensing nozzle is configured to produce a flow of purified water shaped to fill a container having an opening with a diameter of one inch or less.

23. A system according to claim 1 wherein the control means comprises a push button switch.

24. A system according to claim 1 wherein the user interface comprises a display for displaying information about the user account.

25. A method for dispensing water from a water processing system comprising an input connected to receive water from a water supply system and an output configured to dispense a metered amount of processed water, the water processing system defining a closed path between the input and the output, the method comprising:
receiving account information from a card inserted into an insertion slot by means of a contactless smart card system;
determining from the account information whether the inserted card has credits for dispensing water stored thereon; and,
while the inserted card has credits for dispensing water:
activating the water processing system;
receiving a signal to start dispensing water;
dispensing processed water;
debiting an amount of dispensed water from the inserted card; and,
receiving a signal to stop dispensing water.
